(19) United States
(12) Patent Application Publication
(10) Pub. No.: US 2026/0249783 A1
(43) Pub. Date: Aug. 27, 2026

(54) EXTERNALLY MOUNTED RETROFIT POWERED MIRROR ASSEMBLY WITH ORIENTATION STABILITY

(71) Applicant: U.S. Army DEVCOM, Army Research Laboratory, Adelphi, MD (US)

(72) Inventors: Michelle Rosete, Schofiled Barracks, HI (US); Mahdi Al-Husseini, Enterprise, AL (US)

(73) Assignee: U.S. Government, as Represented by the Secretary of the Army, Adelphi, MD (US)

(21) Appl. No.: 19/062,108

(22) Filed: Feb. 25, 2025

(51) Int. Cl. B60R 1/12; B60R 1/00; G02B 26/08

(52) U.S. Cl. CPC B60R 1/12; B60R 1/006; G02B 26/0816; B60R 2001/1223; B60R 2001/1276; B60R 2001/1284

(57) ABSTRACT

A replacement or retrofit power mirror assembly configured to attach to an existing mirror assembly and including an intelligent electronic suite allowing for the automatic reestablishment of a mirror position after the sensing of an external disturbance. The retrofit power mirror assembly may include a customized bracket designed around existing non-powered mirror systems.

### GOVERNMENT INTEREST

The invention described herein may be manufactured and used by or for the Government of the United States for all governmental purposes without the payment of any royalty.

### FIELD OF THE DISCLOSURE

The present disclosure relates generally to a power mirror assembly and, in particular, a retrofit power mirror configured to attach to an existing mirror assembly and including an intelligent electronic suite allowing for the automatic reestablishment of a mirror position after the sensing of an external disturbance.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Driver's side and passenger side powered mirrors can be adjusted to optimize the driver's view and reduce glare, making it easier and safer for the driver to navigate in various weather and lighting conditions. Powered mirrors can also be programmed to adjust to the driver's preferences and remember prior adjustments, improving the driving experience and reducing the need for manual adjustments. The integration of powered mirrors in practically all consumer vehicles exemplifies safety and efficiency in everyday operations. Most military ground vehicles lack powered mirrors however, in part due to an aging overall fleet. It is desirable to provide a system for retrofitting existing vehicles with powered mirrors.

### SUMMARY OF THE INVENTION

Various deficiencies in the prior art are addressed below by the disclosed systems and method for a replacement or retrofit power mirror assembly configured to attach to an existing mirror assembly and including an intelligent electronic suite allowing for the automatic reestablishment of a mirror position after the sensing of an external disturbance. The retrofit power mirror assembly may include a customized bracket configured to enable the power mirror assembly to mount on existing non-powered mirror systems.

A retrofittable powered mirror assembly according to an embodiment may comprise: a mechanical attachment system configured for being externally mounted to an existing vehicle mirror assembly so as to secure the powered mirror assembly thereto; a mechanical adjustment mechanism for adjusting an angle of an existing mirror of the existing vehicle mirror assembly in response to an adjustment signal received from a driver operable device to provide thereby a baseline angle of the mirror; one or more tilt sensors for sensing an angle of the mirror; and a processor, coupled to the one or more tilt sensors and the mechanical adjustment mechanism, for adjusting the angle of the mirror from a sensed mirror angle to the baseline mirror angle in response to determining that a difference between the sensed angle of the mirror and the baseline angle of the mirror is due to an uncommanded change.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a block diagram for an externally mounted retrofit powered mirror system, in accordance with an embodiment of the present invention;

FIG. 2 depicts a flow diagram of a method of operation of the powered mirror system of FIG. 1;

FIGS. 3-4 depict a single actuator embodiment of a mechanical attachment system suitable for use in the system of FIG. 1; and

FIGS. 5-6 depict a dual actuator embodiment of a mechanical attachment system suitable for use in the system 100 of FIG. 1.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments, such as seismology and data fusion.

The ability to retrofit these vehicles with powered mirrors increases vehicle safety and supports overall mission success, allowing teams to accomplish their objectives with greater precision and effectiveness. Currently, vehicle operators must place their hand outside the window to manually adjust the vehicle mirror should external disturbances adjust the mirror vehicle position. The proposed invention seeks to retrofit an aging fleet of military ground vehicles with an intelligent powered mirror system without having to replace existing mirror hardware.

The present invention pertains to a retrofittable mirror assembly, and more particularly to an externally mounted vehicle mirror assembly that adjusts vehicle mirror angle based on one or more switches operable by a vehicle driver, while also stabilizing mirror orientation by continuously sensing and correcting for movement of the vehicle mirror by external disturbances.

Various embodiments contemplate the use of a customized bracket designed around existing non-powered mirror systems in tandem with an intelligent electronic suite to enhance vehicle safety by enabling the remote actuation of a vehicle mirror and allowing for the automatic reestablishment of a mirror position after the sensing of an external disturbance. Embodiments of the present invention discussed in the detailed description and shown in the drawings are not intended to restrict the scope of manned-unmanned wildfire teaming applications, but rather, to illuminate the underpinnings and advantages brought about through variations on the proposed invention. Additional embodiments are also contemplated.

Various embodiments provide a retrofittable mirror assembly, and more particularly to an externally mounted vehicle mirror assembly, separate from the bracket that connects the vehicle to the vehicle mirror, that adjusts vehicle mirror angle based on one or more switches operable by a vehicle driver, while also stabilizing mirror orientation by continuously sensing and correcting for movement of the vehicle mirror by external disturbances. Several embodiments of mirror angle adjustment mechanisms and attachment brackets are presented to encompass a wide variety of vehicle side-view mirrors. The proposed invention is designed to quickly, cheaply, and efficiently modernize the Army's aging ground fleet of vehicles without powered mirrors, to improve overall Soldier safety outcomes.

Various embodiments may use a customized bracket designed around existing non-powered mirror systems in tandem with an intelligent electronic suite to enhance vehicle safety by enabling the remote actuation of a vehicle mirror and allowing for the automatic reestablishment of a mirror position after the sensing of an external disturbance.

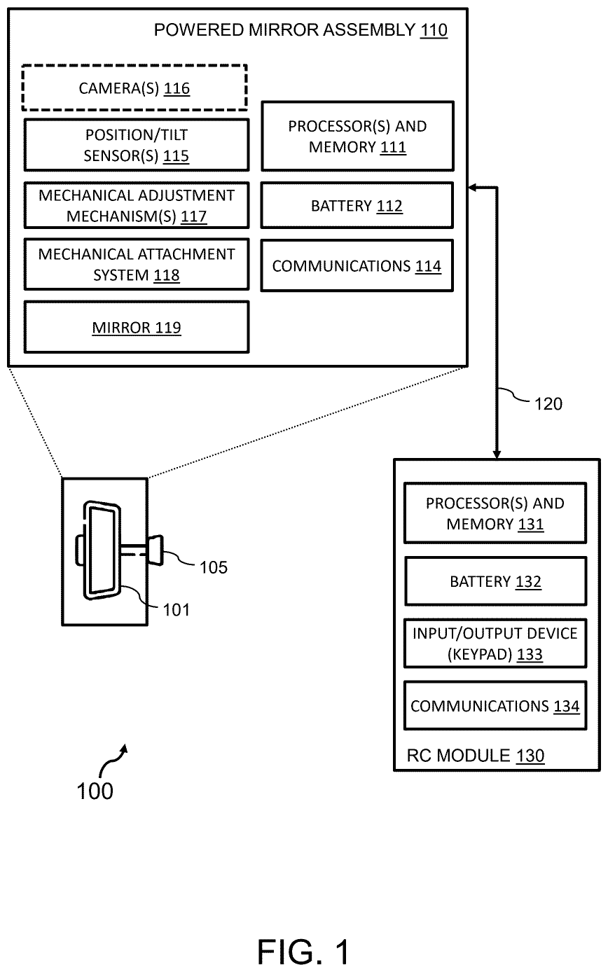

FIG. 1 depicts a block diagram for an externally mounted retrofit powered mirror system, in accordance with an embodiment of the present invention. Specifically, the retrofit powered mirror system 100 comprises a powered mirror assembly 110 configured to be attached to a mounting point 105 of a vehicle (not shown) and to receive various mirror adjustment signals (e.g., tilt/pan adjustment) or control signals (e.g., memory/mode selection) from a control module (RCM) 130 via a wired or wireless communication link 120. The various embodiments contemplate different modes of operation to enable monitoring and readjusting mirror position in the event of unwanted changes to mirror position such as caused by shock/vibrations imparted to the assembly 110 via rough terrain and the like. Generally speaking, the powered mirror assembly 110 is configured for use as an add-on or supplemental assembly to augment existing driver side and/or passenger side manual mirrors on a civilian or military vehicle with a corresponding powered mirror which may be adjusted via driver interaction with the RCM 130. That is, the various embodiments advantageously provide a retrofittable package wherein the majority of the powered mirror assembly components within a retrofittable package can remain the same for different military vehicles with different side mirrors, though the mechanical adjustment mechanism and mechanical attachment system may be altered.

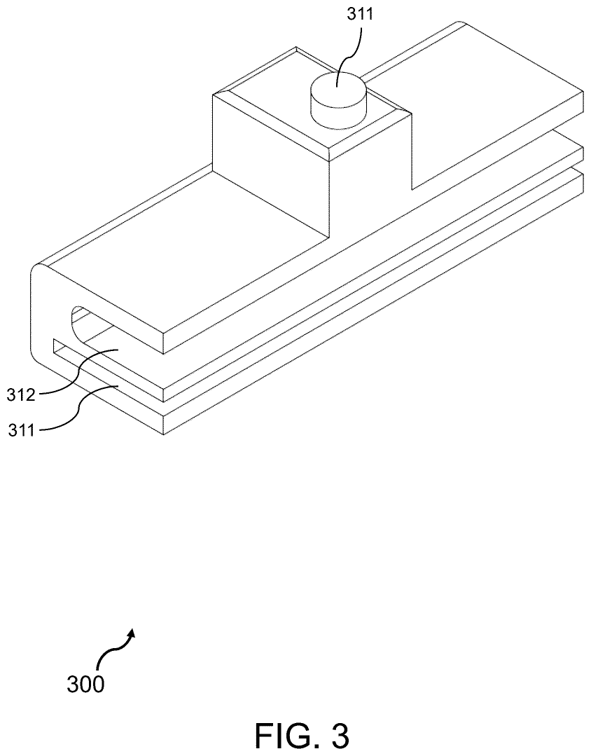

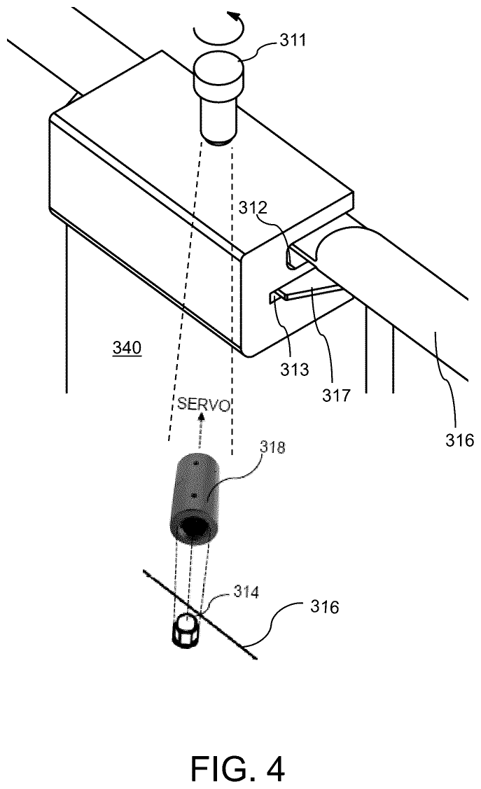

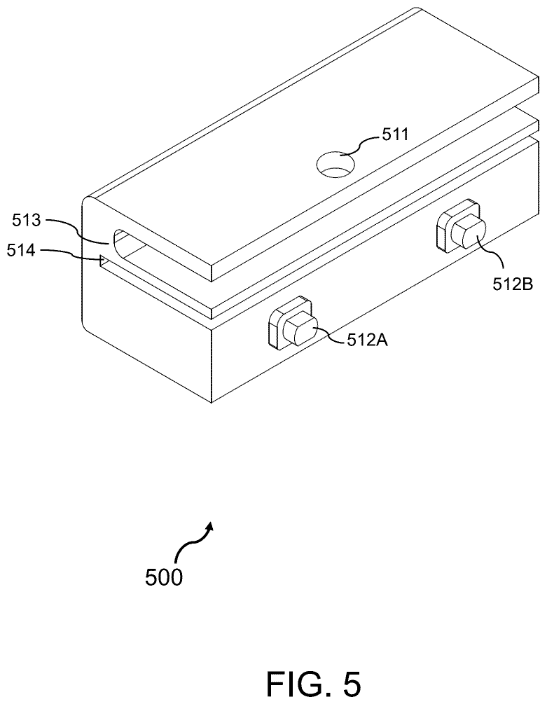

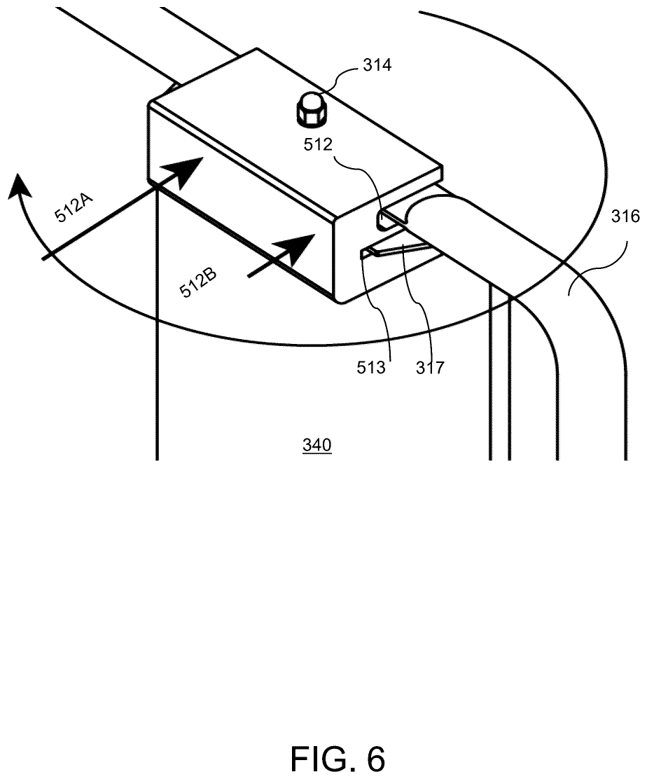

As depicted in FIG. 1, each powered mirror assembly 110 comprises a housing or other enclosure 101 configured to be attached to a mounting point 105 of a vehicle via a mechanical attachment system 118. The mechanical attachment system 118 may comprise any combination of materials to include plastic, metals, and rubbers, and is designed to mount to an existing mirror assembly, to another point on the vehicle, to a location normally configured to hold the existing (standard) mirror assembly, and so on. Two examples of mechanical attachment systems 118 comprise the externally mounted brackets shown in FIGS. 3-4 and in FIGS. 5-6.

The powered mirror assembly 110 comprises various modules/elements such as described herein, which modules/elements may be modified or augmented with various other modules/elements or portions thereof. including one or more processors with memory 111 (e.g., a computing device), battery 112, communications transceiver 114, one or more position/tilt sensors 115, optional camera(s) 116, one or more mechanical adjustment mechanisms 117, a mechanical attachment system 118, at least one mirror 119, and so on.

The processor(s)/memory 111 may comprise processing resources such as processor and/or logic circuitry capable of processing digital information such as ASICs, GPUs, DPUs, and the like, as well memory resources such as volatile and/or non-volatile memory capable of storing data and computing instructions such as ROM, EPROM, EEPROM, flash memory, DRAM, and the like. Generally speaking, the processor(s)/memory 111 include processing resources configured to retrieve and execute programming instructions stored in memory resources such that the processor(s)/memory 111 performs various functions as described herein with respect to the embodiments.

Battery 113 may be an internal battery whose electrical specifications are designed to support the operation of the various components of the powered mirror assembly 110. If differing voltage or current levels are required, then the battery 112 further includes power conditioning circuitry configured to generate power signals of appropriate voltage/current levels.

As depicted in FIG. 1, the least one mirror 119 mechanically cooperates with one or more mechanical adjustment mechanisms 117, each of which are configured to adjust at least one mirror position parameter, such as tilt, pan, and/or some other position parameter. The one or more position/tilt sensors 115 are configured for measuring respective mirror position parameters, such as tilt angle, pan angle/orientation, and so on. Position/tilt sensor(s) 115 may be coupled to the mirror 119, the mechanical adjustment mechanism(s) 117, the mechanical attachment system 118, and/or the housing 101. Other sensors may also be incorporated into the powered mirror assembly 110, such as environmental sensors including accelerometers, pressure sensors, temperature sensors, and so on.

For example, the position/tilt sensors 115 may comprise tilt sensors that continuously sense the mirror angle of a side view mirror 119 and report back to processor(s)/memory 111. Tilt sensors, also known as inclinometers, measure angle, slope, or tilt of the attached objects, and may have digital or analog output signals with various mounting configurations. As is the case with powered mirrors in consumer vehicles, the mirror angle and vehicle mirror angle adjustment mechanism (e.g., mechanical adjustment mechanism 117 and/or mechanical attachment system 118) may be adjusted or maladjusted by disturbances and not the externally mounted retrofit powered mirror assembly 110 whether intentionally (by hand, manually) or unintentionally (due to the impact of environmental factors such as tree branches, vibrations, and the like). Any such disturbances may be recognized through the recording and analysis of position/tilt sensor 115 data over time (even a very small amount of time). If an uncommanded change is sensed (e.g., a change due to a disturbance rather than a comment received from the RCM 130), then processor(s)/memory 111 may cause the mechanical adjustment mechanism(s) to adjust the mirror angle back to, illustratively, a most recent mirror angle baseline established prior to the uncommanded change.

Optional camera(s) 116 may include one or more cameras or other imaging devices positioned to capture useful or relevant imagery, such as the location within the passenger compartment of the driver or driver's head (in the case of a driver's side retrofit power mirror assembly), a location toward the rear of a vehicle having installed thereon a retrofitted powered mirror assembly 110, forward and side looking cameras, and so on. Optional camera(s) 116 need not necessarily operate in, or only in, the visual light spectrum, and may further allow for infrared thermography, to include short wavelength infrared (SWIR), medium wavelength infrared (MWIR), and long wavelength infrared (LWIR). Camera 114 may also integrate night vision light intensification, which amplifies existing visible light. All imagery collected is timestamped and stored in memory 111.

Communications transceiver 114 may comprise one or more transceivers capable of receiving and transmitting data across the communication link 120, which may comprise a wired or wireless interface or network.

A wired communication link 120 suitable for use in the various embodiments may comprise any wired communication links/channels/protocols such as Universal asynchronous receiver-transmitter (UART), Serial Peripheral Interface (SPI), Inter-Integrated Circuit (I2C), and so on.

A wireless communication link 120 suitable for use in the various embodiments may comprise any wireless communication links/channels/protocols such as via radio frequency (RF) communications, optical communications, and so on. Suitable communications links may comprise wireless device/networking protocols such as Bluetooth, 802.11x, WiMAX and so on such as part of a wireless local area network (WLAN), wireless personal area network (WPAN), wireless metropolitan area network (WMAN), wireless wide area network (WWAN), and/or satellite-based network, including in some embodiments wireless telecom protocols such as 3GPP protocols including 4G/LTE, 5G, 6G and so on.

The communication link 120 allows the powered mirror assembly 110 to receive mirror adjustment and other control signals from the remote control module 130. In various embodiments, the communication link 120 also allows the transmission of data such as still and moving camera imagery to the RCM 130 and/or other systems within a vehicle including the powered mirror assembly 110.

As depicted in FIG. 1, the remote control module (RCM) 130 comprises, illustratively, one or more processors with memory 131 (e.g., a computing device), battery 132, input/output (I/O) device 133 (e.g., a keypad, touchscreen, or other input device, optionally including a display), communications transceiver 134, and so on, each of which may be implemented in a manner substantially similar to that described above with respect to corresponding components of the powered mirror assembly 110. The keypad 133 (or other data entry or input control interface) of RCM 130 may manipulated by a driver of a driver or passenger of the vehicle so as to set up and control the mirror and, optionally, other elements of a driver's side or passenger's side retrofitted powered mirror assembly 110.

Generally speaking, a user (driver) begins by actuating RCM 130 to adjust for example a side view mirror orientation to an established vehicle mirror angle baseline. The RCM 130 may contain any number of buttons or switches depending on the complexity of the vehicle mirror angle adjustment mechanism (i.e., mechanical adjustment mechanism(s) 117), and may further comprise an LCD or OLED display for depicting the mirror angle. Notably, the various embodiments are not limited to side view mirrors, and may be used with any unpowered vehicle mirror, whether side view, rear view, or otherwise. Commands from RCM 130 are delivered to communications transceiver 114 via communications link 120, which may operate on any form of wired or wireless network.

Actuation commands received via communications transceiver 114 are stored in memory 111 and delivered to processor 111, where they are translated to instructions for the vehicle mirror angle adjustment mechanism 117. Vehicle mirror angle adjustment mechanism 117 may contain one or more servo motors, stepper motors, and/or electrical motor(s) of any other variety and is responsible for adjusting the vehicle mirror angle relative to, e.g., the mechanical attachment system 118 (e.g., an externally mounted bracket) or some other reference point. Two examples of a vehicle mirror angle adjustment mechanism 117 are a singular servo motor with a coupling to a rotating nut atop a side view mirror, and a coupled set of linear actuators, one on each side of the backend of a side view mirror.

In various embodiments, the mounting bracket is externally mounted to an existing vehicle mirror of claim 1, wherein the bracket does not connect the vehicle mirror to the vehicle itself. In various embodiments, the vehicle mirror angle adjustment motor mechanism may contain any combination of one or more servos, steppers, and other electric motors variants.

Although primarily depicted and described as having specific types and arrangements of components, it will be appreciated that any other suitable types and/or arrangements of components may be used for elements such as the powered mirror assembly 110, wireless communications channel, link, or network 120, RCM 130, and/or any portions thereof. These elements or portions thereof may be implemented via computing devices of various types, though generally a processor element (e.g., a central processing unit (CPU) or other suitable processor(s)), a memory (e.g., random access memory (RAM), read only memory (ROM), and the like), various communications interfaces (e.g., more interfaces enabling communications via different networks/RATs), input/output interfaces (e.g., GUI delivery mechanism, user input reception mechanism, web portal interacting with remote workstations and so on) and the like.

For example, various embodiments are implemented using computing and/or networking equipment used to implement various functions, the equipment comprising processing resources (e.g., one or more servers, processors and/or virtualized processing elements or compute resources) and non-transitory memory resources (e.g., one or more storage devices, memories and/or virtualized memory elements or storage resources), wherein the processing resources are configured to execute software instructions stored in the non-transitory memory resources to implement thereby the various methods and processes described herein. The computing and/or networking equipment may also be used to provide some or all of the various other core network nodes or functions described herein.

As such, the various functions depicted and described herein may be implemented at the elements or portions thereof as hardware or a combination of software and hardware, such as by using a general purpose computer, one or more application specific integrated circuits (ASIC), or any other hardware equivalents or combinations thereof. In various embodiments, computer instructions associated with a function of an element or portion thereof are loaded into a respective memory and executed by a respective processor to implement the respective functions as discussed herein. Thus, various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory or stored within a memory within a computing device operating according to the instructions.

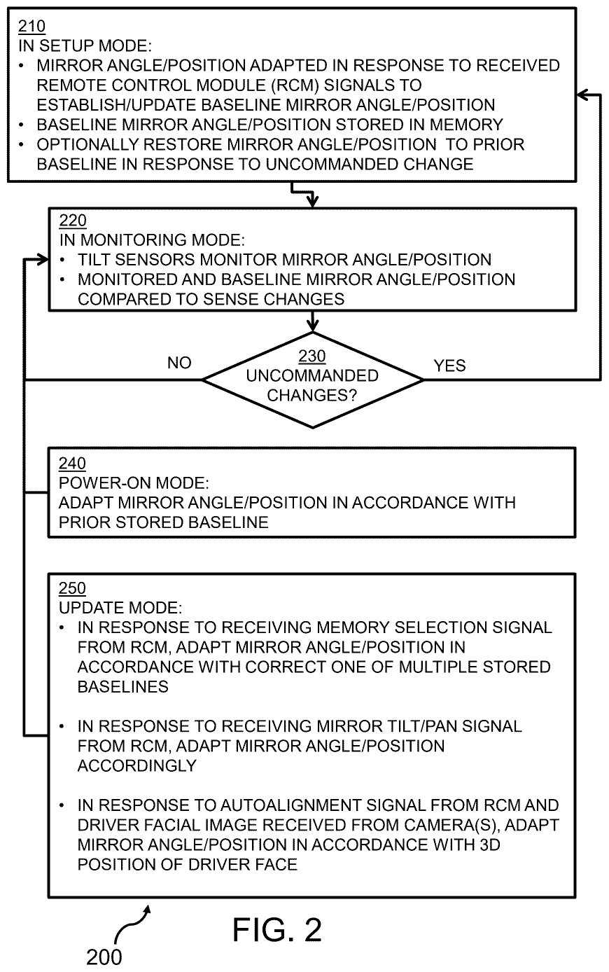

FIG. 2 depicts a flow diagram of a method of operation of the powered mirror system of FIG. 1. Specifically, the method 200 of FIG. 2 illustrates setup and use of an installed powered mirror assembly 110 in accordance with various embodiments.

At step 210, in a setup mode of operation, the method 200 adapts the mirror angle, mirror position, and/or parameter associated with the powered mirror assembly 110 in response to received signals from the RCM 130. If adjusting a mirror 119, the final adjustment made to the mirror 119 are stored in memory as a baseline mirror angle/position, optionally associated with a particular number such as a driver number. Optionally, if the setup mode of operation is entered in response to a detection of an uncommanded change in a tilt, angle, or position of a mirror, the most recent baseline associated with that mirror is retrieved and the mirror is adjusted to the position defined thereby.

At step 220, in a monitoring mode of operation, the tilt sensors and/or other position sensors 115 provide data to the processor(s)/memory 111 suitable for use in determining the current mirror angle, mirror position, and/or other position parameters of each of the one or more mirrors 119 within the installed powered mirror assembly 110.

The method 200 generally operates in the monitoring mode of step 220 until:
(1) a power on condition is detected, in which case the method 200 proceeds to step 240;
(2) a new adjustment or control signal is received from the RCU 130, in which case the method 200 proceeds to step 250; or
(3) a difference between the relevant stored baseline and currently determined mirror angle, mirror position, and/or other position parameter of a mirror exceeding a threshold level, in which case the method proceeds to step 230. The threshold level may be predetermined or user selected (the selection stored with the respective baseline data), such as in terms of a percentage error, a specific amount of tilt/angular/positional difference, and so on.

At step 230, a determination is made as to whether the exceeded difference between the relevant stored baseline and currently determined mirror angle, mirror position, and/or other position parameter of a mirror is due to an uncommanded change (e.g., due to a disturbance of the mirror by external impact/vibration rather than user control). If not commanded, then the method 200 proceeds to step 210 (setup mode) where new setup data may be entered and/or (optionally) the most recent baseline associated with that mirror is retrieved and the mirror is adjusted to the position defined thereby.

At step 240, in a power on mode of operation, the most recent baseline associated with each mirror is retrieved and the respective mirrors adjusted to the positions defined thereby. For example, in various embodiments the processor is configured to recognize a disturbance imparted to the mirror via the tilt sensors and automatically cause the mechanical adjustment mechanism to impart a compensating amount of correction to the angle of the mirror. This may be performed periodically or in substantially real time to provide thereby mirror orientation stability (i.e., reactive changes in vehicle mirror orientation to return vehicle mirror angle to a baseline previously established through the operation of one or more switches operable by a vehicle driver).

At step 250, in an update mode of operation, in response to receiving memory selection signal from the RCM 130 (e.g., storage number, driver number, etc.) the corresponding baseline associated with each mirror is retrieved and the respective mirrors adjusted to the positions defined thereby.

Further at step 250, in response to receiving a mirror tilt/pan/position signal from the RCM 130, the tilt/pan/position of the corresponding mirror 119 is adjusted in accordance with a corresponding one of multiple stored baselines.

Further and optionally at step 250, in response to receiving an auto alignment signal from the RCM 130, the relevant mirror 119 is adjusted in accordance with an auto adjustment routine in which, for example, a camera 116 configured to view the driver portion of a vehicle passenger compartment identifies the head or face or eye location of the driver and responsively adjusts a mirror to a mirror tilt/pan/position that at least roughly corresponds to an appropriate mirror adjustment for that eye location. This process may be automatically invoked for each driver, for each new/different driver, for each time a vehicle is started, and so on.

FIGS. 3-4 depict a single actuator embodiment of a mechanical attachment system suitable for use in the system 100 of FIG. 1. Specifically, the mechanical attachment system 118 of FIGS. 3-4 comprises an externally mounted bracket with accompanying vehicle mirror angle adjustment mechanism clamped onto the side view mirror of a M1120 Heavy Expanded Mobility Tactical Truck Load Handling System, illustratively a passenger side mirror. The mirror possesses a side mount rod 316 which is affixed to the side of the vehicle, that is clamped in port 312. Foam material may be used to line port 312 to ensure a pressure fit of side mount rod 316. Similarly, plate 317 fits into port 313. Embodiment 300 uses a single servo motor 311 coupled to nut cap but 314 via a rod to hex coupling adapter 318. Rotating the shaft of servo motor 311 thus rotates nut cap 314 and adjusts the mirror angle of the M1120 side view mirror 340.

Thus, FIGS. 3-4 depict a retrofittable powered mirror assembly, wherein the mechanical attachment system comprises a bracket configured for rotating a mirror of an existing vehicle mirror assembly via rotational urging of a single actuator.

FIGS. 5-6 depict a dual actuator embodiment of a mechanical attachment system suitable for use in the system 100 of FIG. 1. Specifically, the mechanical attachment system 118 of FIGS. 5-6 comprises an externally mounted bracket with accompanying vehicle mirror angle adjustment mechanism clamped onto the side view mirror of a M1120 Heavy Expanded Mobility Tactical Truck Load Handling System, illustratively a passenger side mirror. The mirror possesses a side mount rod 316 which is affixed to the side of the vehicle, that is clamped in port 513. Foam material may be used to line port 513 to ensure a pressure fit of side mount rod 316. Similarly, plate 317 fits into port 513. The embodiment of FIGS. 5-6 uses a coupled set of linear actuators 512A/512B that push the lateral sides of side view mirror 340 on respective inner and outer portions thereof with respect to nut cap 314, which extends through an opening 511 of the attachment system 500 and enables rotation of the side view mirror 340 thereat. That is, the dual actuators 512A/512B provide a differential application of force to the existing mirror 340 to cause a rotation thereof about a rod axially aligned with and secured by nut cap 314.

Thus, FIGS. 5-6 depict a retrofittable powered mirror assembly, wherein the mechanical attachment system comprises a bracket configured for rotating a mirror of the existing vehicle mirror assembly via rotational urging of a pair of actuators, a first actuator urging rotation of the mirror in a first direction and a second actuator urging rotation of the mirror in a second direction, the second direction opposite the first direction.

Various embodiments may comprise an externally mounted retrofit powered mirror assembly comprising: a bracket externally mounted to an existing vehicle mirror; a vehicle mirror angle adjustment motor mechanism for adjusting the vehicle mirror angle relative to the externally mounted bracket; one or more switches operable by a vehicle driver, for actuating the vehicle mirror angle adjustment motor mechanism; one or more tilt sensors for sensing vehicle mirror angle; a processor for recognizing external disturbances as determined with one or more angular position sensors and for controlling the vehicle mirror angle adjustment motor mechanism accordingly to ensure orientation stability; and a transceiver for transmitting and receiving vehicle mirror angle adjustment commands from one or more switches operable by the vehicle driver to a processor for processing. The bracket may externally mount to an existing vehicle mirror, wherein the bracket does not connect the vehicle mirror to the vehicle itself. The motor mechanism may contain any combination of one or more servos, steppers, and other electric motors variants. The one or more switches may be operable by a vehicle driver to control the movement of the vehicle mirror in any direction. External disturbances may be defined as changes in vehicle mirror angle not instantiated through the operation of one or more switches operable by a vehicle driver, and orientation stability may be defined as reactive changes in vehicle mirror orientation to return vehicle mirror angle to a baseline previously established through the operation of one or more switches operable by a vehicle driver. The transceiver may encompass a separate transmitter and receiver which may communicate via wired or wireless means.

Various embodiments may comprise a method for using an externally mounted retrofit powered mirror assembly to adjust an existing vehicle mirror while ensuring orientation stability, including: one or more switches being operated by a vehicle driver to define a vehicle mirror angle baseline, the vehicle mirror angle baseline which is then transmitted to a processor; a processor commanding a vehicle mirror angle adjustment motor mechanism to adjust the vehicle mirror angle to the transmitted vehicle mirror angle baseline, the vehicle mirror angle adjustment motor mechanism adjusting the vehicle mirror angle relative to an externally mounted bracket; one or more tilt sensors continuously sensing for adjustments made to the vehicle mirror angle by external disturbances; the processor ensuring orientation stability by commanding the vehicle mirror angle adjustment motor mechanism to adjust the vehicle mirror angle back to the last transmitted vehicle mirror angle baseline, should the vehicle mirror angle be affected by external disturbances. The externally mounted bracket may or may not connect the vehicle mirror to the vehicle itself. The vehicle mirror angle adjustment motor mechanism may contain any combination of one or more servos, steppers, and other electric motors variants. One or more switches operable by a vehicle driver may control the movement of the vehicle mirror in any direction.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A retrofittable powered mirror assembly, comprising:
a mechanical attachment system configured for being externally mounted to an existing vehicle mirror assembly so as to secure the powered mirror assembly thereto;
a mechanical adjustment mechanism for adjusting an angle of an existing mirror of the existing vehicle mirror assembly in response to an adjustment signal received from a driver operable device to provide thereby a baseline angle of the mirror;
one or more tilt sensors for sensing an angle of the mirror; and
a processor, coupled to the one or more tilt sensors and the mechanical adjustment mechanism, for adjusting the angle of the mirror from a sensed mirror angle to the baseline mirror angle in response to determining that a difference between the sensed angle of the mirror and the baseline angle of the mirror is due to an uncommanded change.

2. The retrofittable powered mirror assembly of claim 1, wherein the mechanical attachment system comprises a bracket mounted to an existing vehicle mirror.

3. The retrofittable powered mirror assembly of claim 1, wherein the angle of an existing mirror is determined with respect to the mechanical attachment system.

4. The retrofittable powered mirror assembly of claim 1, wherein the adjustment signal is received from a driver operable device via a wired communication link therebetween.

5. The retrofittable powered mirror assembly of claim 4, wherein the wired communication link comprises one of a Universal asynchronous receiver-transmitter (UART), Serial Peripheral Interface (SPI), and Inter-Integrated Circuit (I2C) communications link.

6. The retrofittable powered mirror assembly of claim 1, wherein the adjustment signal is received from a driver operable device via a wireless communication link therebetween.

7. The retrofittable powered mirror assembly of claim 1, wherein the wireless communication link comprises a wireless networking protocol.

8. The retrofittable powered mirror assembly of claim 1, wherein the processor is configured to recognize a disturbance imparted to the mirror via the tilt sensors and automatically cause the mechanical adjustment mechanism to impart a compensating amount of correction to the angle of the mirror.

9. The retrofittable powered mirror assembly of claim 8, wherein the sensing and compensation for disturbance imparted to the mirror is continuously provided in substantially real time.

10. The retrofittable powered mirror assembly of claim 1, wherein the mechanical attachment system comprises a bracket configured for rotating a mirror of the existing vehicle mirror assembly via rotational urging of a single actuator.

11. The retrofittable powered mirror assembly of claim 1, wherein the mechanical attachment system comprises a bracket configured for rotating a mirror of the existing vehicle mirror assembly via rotational urging of a pair of actuators, a first actuator urging rotation of the mirror in a first direction and a second actuator urging rotation of the mirror in a second direction, the second direction opposite the first direction.
